(19) United States
(12) Patent Application Publication
(10) Pub. No.: US 2014/0053721 A1
(43) Pub. Date: Feb. 27, 2014

(54) MASTER CYLINDER

(71) Applicant: Advics Co., Ltd., Kariya-city (JP)

(72) Inventor: Satoshi Ishida, Aichi-ken (JP)

(73) Assignee: ADVICS CO., LTD., Kariya-city (JP)

(21) Appl. No.: 13/975,585

(22) Filed: Aug. 26, 2013

(30) Foreign Application Priority Data
Aug. 24, 2012 (JP) 2012-185248

(51) Int. Cl. F16J 1/12

(52) U.S. Cl. CPC F16J 1/12
USPC 92/172

(57) ABSTRACT

An input piston and an input rod of a master cylinder are connected such that a spherical tip portion of the input rod is integrally connected in an axial direction and tiltably connected in a radial direction to a concave portion in a bottom portion of a piston inner hole. A sphere diameter of the spherical tip portion is larger than the maximum diameter of a shaft portion in the input rod. The concave portion of the input piston has a conical bottom portion that receives the spherical tip portion and a cylindrical hole portion that can accommodate the spherical tip portion, and the concave portion is formed in the input piston itself. An opening-side end portion of the cylindrical hole portion is configured to be pressed and molded in the axial direction and an inner radial direction by use of a fixture to retain the spherical tip portion.

### TECHNOLOGICAL FIELD

The present invention relates to a master cylinder, particularly to a master cylinder that includes a cylinder body having a cylinder inner bore; an input piston which is movably assembled in a cylinder axis direction into the cylinder inner bore of the cylinder body to form a hydraulic chamber in the cylinder body, and an end portion of which is protruded to the outside from the cylinder body; and an input rod which is inserted through a piston inner hole formed coaxially with the center of an axis of the input piston, which has a spherical tip portion integrally connected in an axial direction and tiltably connected in a radial direction to a concave portion that is provided in a bottom portion of the piston inner hole, and which is operated by a brake pedal.

### BACKGROUND DISCUSSION

This type of master cylinder is disclosed in JP1999-34852A and JP2012-66692A. In the master cylinder disclosed in JP1999-34852A, the sphere diameter of the spherical tip portion of the input rod is set to be smaller than the maximum diameter of a shaft portion of the input rod by a predetermined amount. In addition, an input member is assembled in the piston inner hole of the input piston, and the concave portion is formed in the input member. The input member has a threaded portion that passes through the input piston, and a contact member (nut) is screwed onto the threaded portion, and thus, the input piston, the input member, the contact member and the like are integrated with each other.

In addition, in the master cylinder disclosed in JP2012-66692A (refer to FIGS. 7 and 8), the sphere diameter of the spherical tip portion of the input rod is set to be smaller than the maximum diameter of the shaft portion of the input rod by a predetermined amount. In addition, the concave portion has a conical bottom portion that receives the spherical tip portion and a cylindrical hole portion that can accommodate the spherical tip portion within the diameter thereof, and the concave portion is formed in the input piston itself and an opening-side end portion of the cylindrical hole portion is pressed and molded to retain the spherical tip portion.

In the master cylinder disclosed in JP1999-34852A, it is assumed that, before the input rod and the input member are assembled into the input piston, the opening-side end portion of the cylindrical hole portion in the concave portion formed in the input member is pressed and molded from the outer periphery to an inner radial direction to retain the spherical tip portion, and the input rod and the input member are integrated with each other in advance. For this reason, it is considered that a necessary and sufficient connecting strength can be ensured in a connecting portion between the input rod and the input member. However, in the master cylinder, components such as the input member and the contact member are required for the connection of the input piston and the input rod, and thus, an increase in cost is unavoidable.

On the other hand, since the input piston and the input rod are directly connected to each other in the master cylinder disclosed in JP2012-66692A, costs can be reduced compared to the connection of the input piston and the input rod in the master cylinder disclosed in JP1999-34852A. In this master cylinder, it is assumed that the opening-side end portion of the cylindrical hole portion is pressed and molded by use of a cylindrical-shaped fixture (more specifically, a fixture that has the diameter of an inner hole larger than the maximum diameter of the shaft portion of the input rod and can be inserted into the piston inner hole of the input piston). However, even in this master cylinder, the sphere diameter of the spherical tip portion of the input rod is set to be smaller than the maximum diameter of the shaft portion in the input rod by a predetermined amount. For this reason, in this master cylinder, a region formed by a press molding by use of the cylindrical fixture is a region where the diameter is larger than the sphere diameter (the same diameter as the hole diameter of the cylindrical hole portion of the concave portion) of the spherical tip portion by a predetermined amount and the press molding is difficult to be performed in both of the axial and inner radial directions. Accordingly, it is difficult to engage a portion of the input piston with the spherical tip portion of the input rod by the necessary and sufficient amount of engagement and to ensure a necessary and sufficient connecting strength in the connecting portion between the input piston and the input rod.

### SUMMARY

The present invention is made in light of the aforementioned problems (an object of the present invention is to ensure a necessary and sufficient connecting strength at low cost in a connecting portion between an input piston and an input rod of a master cylinder), and provides a master cylinder that includes a cylinder body having a cylinder inner bore; an input piston which is movably assembled in a cylinder axis direction into the cylinder inner bore of the cylinder body to form a hydraulic chamber in the cylinder body, and an end portion of which is protruded to the outside from the cylinder body; and an input rod which is inserted through a piston inner hole formed coaxially with the center of an axis of the input piston, which has a spherical tip portion integrally connected in an axial direction and tiltably connected in a radial direction to a concave portion that is provided in a bottom portion of the piston inner hole, and which is operated by a brake pedal. The sphere diameter of the spherical tip portion of the input rod is set to be larger than the maximum diameter of a shaft portion of the input rod by a predetermined amount. The concave portion has a conical bottom portion that receives the spherical tip portion and a cylindrical hole portion that can accommodate the spherical tip portion within the diameter thereof, the concave portion is formed in the input piston itself, and an opening-side end portion of the cylindrical hole portion is pressed and molded in the axial and inner radial directions to retain the spherical tip portion.

In the aforementioned master cylinder according to the present invention, since the concave portion is formed in the input piston itself and the sphere diameter of the spherical tip portion in the input rod is set to be larger than the maximum diameter of the shaft portion of the input rod by a predetermined amount, when the opening-side end portion of the cylindrical hole portion in the concave portion is pressed and molded in the axial and inner radial directions in a state where the spherical tip portion of the input rod is fitted into the concave portion of the input piston, a fixture with a simple shape (more specifically, a cylindrical fixture that has an inner hole having a diameter smaller than the sphere diameter of the spherical tip portion in the input rod and larger than the maximum diameter of the shaft portion in the input rod, that has an inner hole portion which can be fitted to the entire shaft portion and a portion of the spherical tip portion in the input rod, and that can be inserted into the piston inner hole of the input piston) can be used.

In addition, in the aforementioned master cylinder according to the present invention, since the opening-side end portion of the cylindrical hole portion in the concave portion can be pressed and molded in the axial and inner radial directions by use of the fixture, a portion of the input piston can be engaged with the spherical tip portion of the input rod by the necessary and sufficient amount of engagement. For this reason, a necessary and sufficient connecting strength can be ensured in the connecting portion (the concave portion of the input piston and the spherical tip portion of the input rod) between the input piston and the input rod.

### BRIEF DESCRIPTION OF THE DRAWING FIGURES

FIG. 1 is a cross-sectional view of a main part in an embodiment of a master cylinder according to the present invention.

FIG. 2 is a partially enlarged cross-sectional view illustrating a state where an input piston and an input rod in FIG. 1 are not connected to each other.

FIG. 3 is a partially enlarged cross-sectional view illustrating a state where the input piston and the input rod in FIG. 1 are connected to each other.

FIG. 4 is an enlarged cross-sectional view of a main part in FIG. 2.

FIG. 5 is an enlarged cross-sectional view of a main part in FIG. 4.

FIG. 6 is an enlarged cross-sectional view of a main part equivalent to FIG. 4 illustrating a modification embodiment according to the present invention.

FIG. 7 is an enlarged cross-sectional view of a main part equivalent to FIG. 5 illustrating a modification embodiment according to the present invention.

### DETAILED DESCRIPTION

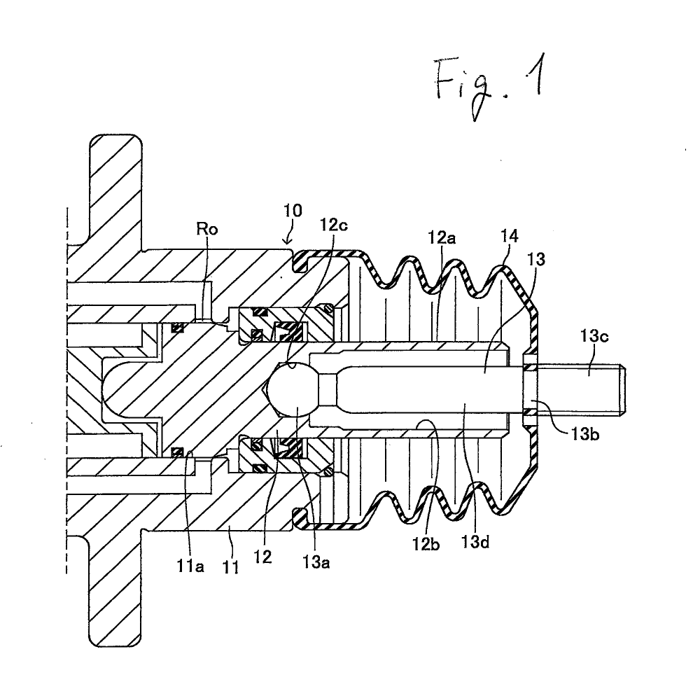

Hereinafter, embodiments of the present invention will be described with reference to the accompanying drawings. FIG. 1 illustrates an embodiment of a master cylinder according to the present invention, a master cylinder 10 includes a cylinder body 11 with a cylinder inner bore 11a; an input piston 12 that is assembled into the cylinder inner bore 11a of the cylinder body 11; and an input rod 13 that is connected to the input piston 12.

The input piston 12 is movably assembled in a cylinder axis direction into the cylinder inner bore 11a of the cylinder body 11 to form a hydraulic chamber Ro in the cylinder body 11. In addition, a right end portion 12a of the input piston 12 in FIG. 1 is protruded to the outside from the cylinder body 11, and an outer periphery of the input piston 12 is protectively covered with a boot 14 that is provided over the cylinder body 11 and the input rod 13. In addition, a piston inner hole 12b and a concave portion 12c are provided in the right end portion 12a of the input piston 12. The piston inner hole 12b is formed coaxially with the center of an axis of the input piston 12 and a right end thereof is open. The concave portion 12c is provided in a bottom portion of the piston inner hole 12b.

The input rod 13 is inserted through the piston inner hole 12b of the input piston 12, and a spherical tip portion 13a of the input rod 13 is integrally connected in an axial direction and tiltably connected in a radial direction to the concave portion 12c of the input piston 12. In addition, the input rod 13 has an annular groove 13b and a threaded shaft portion 13c in a portion where the input rod 13 is protruded to the outside from the piston inner hole 12b. The annular groove 13b is a groove to which an end portion of the boot 14 is fixed. The threaded shaft portion 13c is a portion that is connected to a brake pedal (not illustrated), and is integrally connected to the spherical tip portion 13a via a connecting shaft portion 13d. For this reason, the input rod 13 is configured to be operated by the brake pedal (not illustrated).

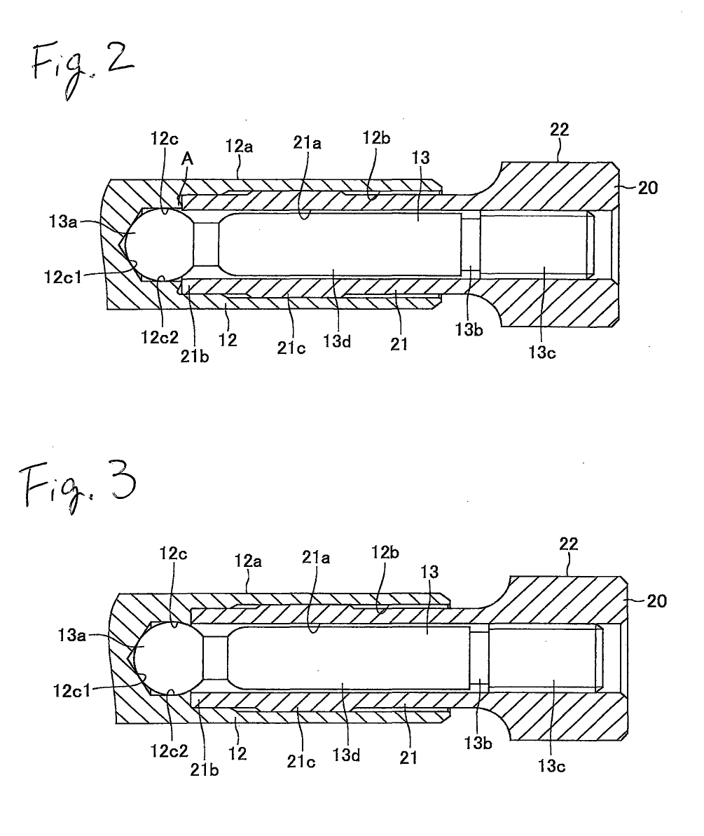

In the embodiment, the sphere diameter of the spherical tip portion 13a in the input rod 13 is set to be larger than the maximum diameter (the diameter of the threaded shaft portion 13c in the embodiment) of a shaft portion (the threaded shaft portion 13c and the connecting shaft portion 13d) in the input rod 13 by a predetermined amount. In addition, as enlargedly illustrated in FIGS. 2 to 5, the concave portion 12c has a conical bottom portion 12c1 that receives the spherical tip portion 13a and a cylindrical hole portion 12c2 that can accommodate the spherical tip portion 13a within the diameter thereof, the concave portion 12c is formed in the input piston 12 itself, and an opening-side end portion A of the cylindrical hole portion 12c2 is pressed and molded in the axial and inner radial directions to retain the spherical tip portion 13a.

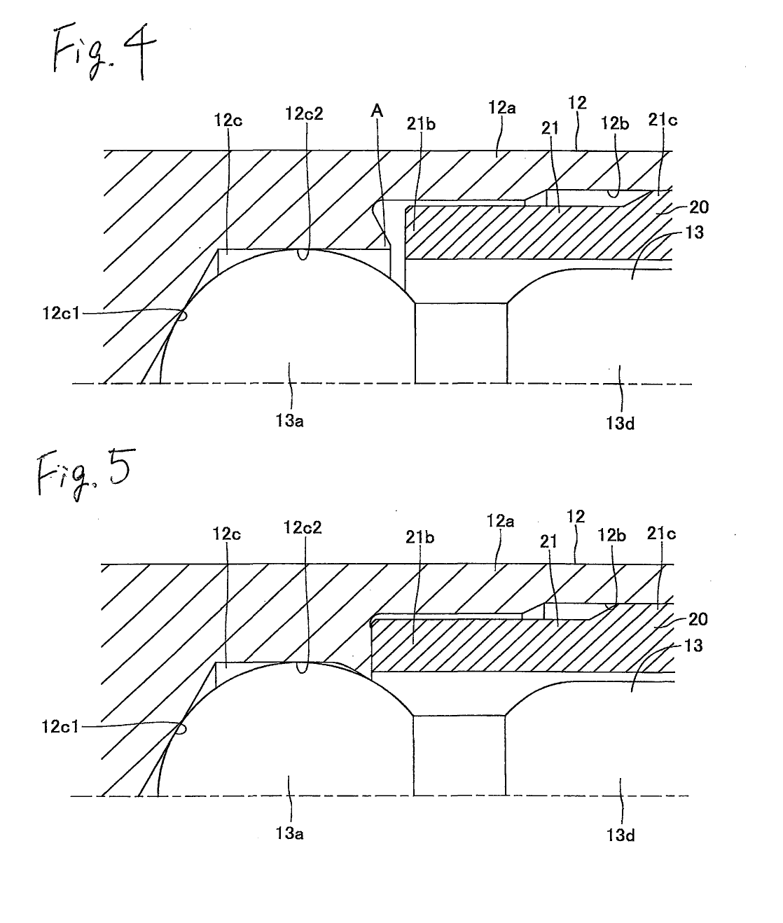

In addition, in the embodiment, the opening-side end portion A (a portion that is pressed and molded in the axial and inner radial directions by a fixture 20 which will be described later) of the cylindrical hole portion 12c2 in the concave portion 12c has an annular shape, and, as illustrated in FIGS. 2 and 4, before the opening-side end portion A is pressed and molded, the opening-side end portion A is formed to be protruded toward an opening by a predetermined amount, and an outer periphery thereof is formed to have a tapered shape where a diameter reduction is made toward the opening.

In the aforementioned master cylinder 10 according to the embodiment, the concave portion 12c is formed in the input piston 12 itself, the sphere diameter of the spherical tip portion 13a in the input rod 13 is set to be larger than the maximum diameter (the diameter of the threaded shaft portion 13c) of the shaft portion in the input rod 13 by a predetermined amount. For this reason, when the opening-side end portion A of the cylindrical hole portion 12c2 in the concave portion 12c is pressed and molded in the axial and inner radial directions in a state where the spherical tip portion 13a of the input rod 13 is fitted into the concave portion 12c of the input piston 12, the fixture 20 with a simple shape (more specifically, the cylindrical fixture 20 that has an inner hole 21a having a diameter smaller than the sphere diameter of the spherical tip portion 13a in the input rod 13 and larger than the maximum diameter (the diameter of the threaded shaft portion 13c) of the shaft portion in the input rod 13, that has an inner hole portion (small-diameter portion) 21 which can be fitted to the entire shaft portion (the threaded shaft 13c and the connecting shaft portion 13d) and a portion of the spherical tip portion 13a in the input rod 13, and that can be inserted into the piston inner hole 12b of the input piston 12) can be used.

In the aforementioned fixture 20, a tip portion 21b of the inner hole portion (small-diameter portion) 21 is a portion that presses and molds the opening-side end portion A of the cylindrical hole portion 12c2 in the concave portion 12c in the axial and inner radial directions, and the outer diameter of the tip portion 21b is set to be slightly smaller than the inner diameter of a small-diameter portion of the piston inner hole 12b (refer to FIG. 4). In addition, a guiding portion 21c is formed in an intermediate portion of the inner hole portion (small-diameter portion) 21 in the axial direction. The guiding portion 21c is formed to have the same diameter as the inner diameter of a large-diameter portion of the piston inner hole 12b, and the guiding portion 21c is assembled slidably in the axial direction assembled into the large-diameter portion of the piston inner hole 12b. A large-diameter portion 22 (refer to FIGS. 2 and 3) of the fixture 20 is a portion that is fixed to a press molding machine (not illustrated), and the fixture 20 is configured to be driven in the axial direction by the press molding machine (not illustrated).

In addition, in the embodiment, when the opening-side end portion A of the cylindrical hole portion 12c2 in the concave portion 12c is pressed and molded in the axial and inner radial directions, in a state where the input rod 13 is combined with the input piston 12 (as illustrated in FIGS. 2 and 4, a state where the spherical tip portion 13a of the input rod 13 is fitted into the concave portion 12c of the input piston 12), the aforementioned fixture 20 is put inbetween the input piston 12 and the input rod 13 and is pressed in the axial direction (simple operation). Accordingly, the opening-side end portion A of the cylindrical hole portion 12c2 in the concave portion 12c of the input piston 12 can be pressed and molded (caulking). For this reason, an operation of connecting the input piston 12 and the input rod 13 is facilitated.

In addition, in the aforementioned master cylinder 10 according to the embodiment, since the opening-side end portion A of the cylindrical hole portion 12c2 in the concave portion 12c can be pressed and molded in the axial and inner radial directions by use of the aforementioned fixture 20, a portion (opening-side end portion A) of the input piston 12 can be engaged with the spherical tip portion 13a of the input rod 13 by the necessary and sufficient amount of engagement. For this reason, a necessary and sufficient connecting strength can be ensured in a connecting portion (concave portion 12c of the input piston 12 and spherical tip portion 13a of the input rod 13) between the input piston 12 and the input rod 13.

In addition, in the embodiment, before the opening-side portion A of the cylindrical hole portion 12c2 in the concave portion 12c is pressed and molded, the opening-side end portion A is formed to be protruded toward the opening by a predetermined amount, and the outer periphery thereof is formed to have a tapered shape where a diameter reduction is made toward the opening. That is, since the portion (caulked portion) that is pressed and molded by the fixture 20 has a shape protruded toward the opening by a predetermined amount before the portion is pressed and molded, a press molding load can be reduced compared to a case where the portion (caulked portion) has a flat shape (shape where the portion is formed not to be protruded toward the opening) before the portion is pressed and molded. In addition, since the outer periphery of the portion (opening-side end portion A) that is formed to be protruded by a predetermined amount is formed to have a tapered shape where a diameter reduction is made toward the opening, moldability (fluidity of a material for the input piston) of the press-molded portion toward the spherical tip portion 13a can be improved.

In the aforementioned embodiment, as illustrated in FIG. 4, the outer periphery of the opening-side end portion A of the cylindrical hole portion 12c2 in the concave portion 12c is formed to be tapered to the vicinity of the small-diameter portion of the piston inner hole 12b. However, as illustrated in FIG. 6, when the present invention is embodied, the shape of the opening-side end portion A can also be changed to be embodied. A large-diameter portion of the tapered portion in the opening-side end portion A illustrated in FIG. 6 is formed to have a diameter smaller than a large-diameter portion of the tapered portion illustrated in FIG. 4, and an annular stopper surface S is formed in the outer periphery of the tapered portion.

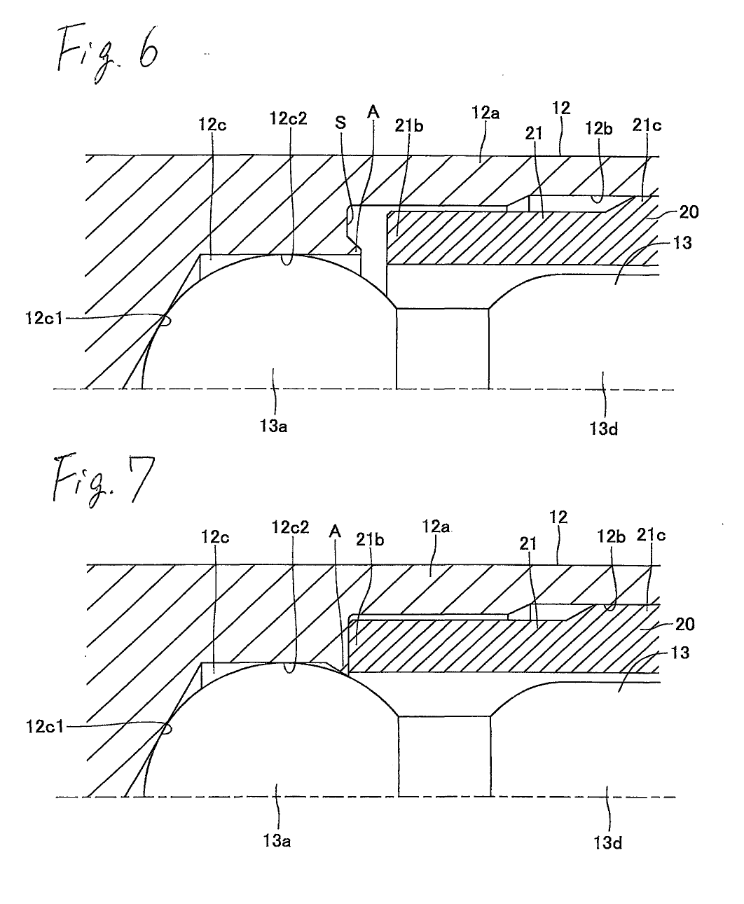

For this reason, in modification embodiments illustrated in FIGS. 6 and 7, when a press molding is performed by use of the fixture 20, a press-in operation of the fixture 20 can be regulated by the annular stopper surface S, and an excessive press molding (caulking) can be prevented. Accordingly, an excessive connection (connection where the input piston 12 and the input rod 13 are not easily tiltable to each other) of the input piston 12 and the input rod 13 can be prevented.

What is claimed is:

1. A master cylinder comprising:
a cylinder body having a cylinder inner bore;
an input piston which is movably assembled in a cylinder axis direction into the cylinder inner bore of the cylinder body to form a hydraulic chamber in the cylinder body, and an end portion of which is protruded to the outside from the cylinder body; and
an input rod which is inserted through a piston inner hole formed coaxially with the center of an axis of the input piston, which has a spherical tip portion integrally connected in an axial direction and tiltably connected in a radial direction to a concave portion that is provided in a bottom portion of the piston inner hole, and which is operated by a brake pedal,
wherein the sphere diameter of the spherical tip portion in the input rod is set to be larger than the maximum diameter of a shaft portion in the input rod by a predetermined amount, and
wherein the concave portion has a conical bottom portion that receives the spherical tip portion and a cylindrical hole portion that can accommodate the spherical tip portion within the diameter thereof, the concave portion is formed in the input piston itself, and an opening-side end portion of the cylindrical hole portion is pressed and molded in the axial direction and an inner radial direction to retain the spherical tip portion.

2. The master cylinder according to claim 1,
wherein, before the opening-side end portion of the cylindrical hole portion in the concave portion is pressed and molded, the opening-side end portion is formed to be protruded toward an opening by a predetermined amount, and an outer periphery thereof is formed to have a tapered shape where a diameter reduction is made toward the opening.

3. The master cylinder according to claim 2,
wherein an annular stopper surface is formed in an outer periphery of the tapper-shaped portion.
